(19) United States
(12) Patent Application Publication
(10) Pub. No.: US 2008/0102533 A1
(43) Pub. Date: May 1, 2008

(54) Apparatus and method for measuring specific heat using flash

(76) Inventor: Seog Kwang Kim, Yusung-gu (KR)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/796,437

(22) Filed: Apr. 27, 2007

(30) Foreign Application Priority Data
Oct. 27, 2006 (KR) 10-2006-104968

(51) Int. Cl. G01N 25/20; G01N 21/01

(52) U.S. Cl. 436/147; 422/82.05

(57) ABSTRACT

The present invention relates to an apparatus and method for measuring specific heat using flash. To this end, the specific heat measurement apparatus includes sample fixing means for fixing a sample 50 so that each of both surfaces 52, 55 of the sample 50 is partially exposed, flash irradiation means for irradiating flash to one surface 52 of the sample 50, which is exposed by the sample fixing means, a light-receiving detector for receiving light irradiated from the other surface 55 of the sample 50, which is exposed by the sample fixing means, and a calculation unit 74 for calculating specific heat of the sample 50 based on an output signal of the light-receiving detector.

### BACKGROUND OF THE INVENTION

1. Field of the Invention

The present invention relates, in general, to specific heat measurement, and more particularly, to an apparatus and method for measuring specific heat using flash.

2. Background of the Related Art

Thermal physical properties (thermal diffusivity, specific heat, thermal conductivity) are unique to a material system, and accurate measurement of the thermal physical properties is important in application techniques in terms of thermal transfer analysis and engineering. In particular, as new materials having a good thermal characteristic and special functional materials are actively developed in line with the development of the industry, accurate measurement for securing rapidness and reliability, which can be applied to new materials, is required.

Meanwhile, the flash method is a method of eliminating contact resistance at normal state, which was inherent in the existing thermal conductivity measurement, and was developed for thermal diffusivity measurement. The advantages of the laser flash method includes measurement for a short period of time, easy data acquisition, a smaller size of a sample, and measurement with high accuracy up to a wide range of the temperature range. Thus, the laser flash method has recently been widely used along with lots of developments.

In order to measure the thermal conductivity k using the flash method, the thermal conductivity k can be found from the following Equation 1.

k=ρCₚα (1)

where the thermal diffusivity α, the specific heat Cₚ using a Differential Scanning Calorimetry (DSC) method, and the sample density ρ employing Archimedes' Principle are obtained. The density ρ can be obtained relatively simply, but the specific heat measurement using the DSC method takes lots of time since three-step measurement, including an empty vessel, a standard sample and a test sample, is required. Thus, a method of measuring the thermal diffusivity and the specific heat at the same time using the flash method without additional specific heat measurement equipment has been researched and commercialized, but there has been great error.

H. Watanabe (Chemical Geology, Watanabe, H. v. 70 no. 1/2, 1988, p. 90) calculated the specific heat by comparing the maximum temperatures at the rear surfaces of a standard sample and a test sample. Shinzato, etc. (J. ther. analy. cal. Shinzato, K. and Baba, T. v. 64 no. 1, 2001, pp. 413-422) compared the specific heat at a temperature at the half time when temperatures at the rear surfaces of a standard sample and a test sample reached the highest. However, it was recommended that the thickness and the thermal physical properties of the standard and test samples were similar, but there has been an error of 10% or higher in reality. Thus, today, the measurement of the specific heat almost depends on the DSC method.

However, the specific heat using the existing DSC method largely depends on the accuracy of the degree of contact of the sample and bottom surface of the vessel.

The measurement error by the (DSC) method is large due to the difference in the processed mass of the standard sample and the (measured) sample, which must be the same. Furthermore, the thickness of the test sample must be limited to within 1 mm, and should not be high because of a temperature delay phenomenon.

Accordingly, the method has lots of difficulties in accurate measurement and is accompanied by many error factors.

### SUMMARY OF THE INVENTION

Accordingly, the present invention has been made in an effort to solve the above problems occurring in the prior art, and it is an object of the present invention to provide an apparatus and method for measuring specific heat using flash, in which the thermal diffusivity and the specific heat can be measured at the same time accurately, and the thermal conductivity can be measured further rapidly and accurately by developing a new method of measuring the specific heat from thermal diffusivity data using the flash method.

The object of the present invention can be accomplished by a specific heat measurement apparatus using flash, including sample fixing means for fixing a sample so that each of both surfaces of the sample is partially exposed, flash irradiation means for irradiating flash to one surface of the sample, which is exposed by the sample fixing means, a light-receiving detector for receiving light irradiated from the other surface of the sample, which is exposed by the sample fixing means, and a calculation unit for calculating specific heat of the sample based on an output signal of the light-receiving detector.

Further, the sample fixing means may include a sample holder having a first holder hole formed penetratingly therein so that the one surface of the sample is exposed and a second holder hole for accommodating the sample therein, a sample cover placed on the sample holder and having a covering hole formed penetratingly therein so that the other surface of the sample is exposed, and a sample holder plate in which the sample holder is seated.

In addition, the sample holder plate may include a first sample holder plate formed with a first through-hole for inserting the sample holder thereto, and a second sample holder plate fixed closely to one surface of the first sample holder plate and having a second through-hole formed therein, the second through-hole being smaller than the first through-hole.

Further, it is favorable that plural pairs of first and second through-holes are formed in the first and second sample holder plates. Further, the flash irradiation means may include a laser oscillation unit or a xenon flash, and the flash irradiated by the flash irradiation means may include a pulse wave. Furthermore, the light-receiving detector may include an infrared detector. It is also favorable that black graphite is coated on the both surfaces of the sample.

The object of the present invention can be accomplished by a specific heat measurement method using flash, including a sample fixing step of fixing a sample whose specific heat will be measured so that each of both surfaces of the sample is partially exposed, a step of allowing a light-receiving detector to measure light at the other surface of the sample, a first calculation step of calculating a temperature change at the other surface of the sample according to the lapse of time t based on an output signal of the light-receiving detector, a second calculation step of calculating the temperature change by performing the sample fixing step to the first calculation step with respect to a standard sample having a known specific heat Cₚᵣ, and a third calculation step of calculating a specific heat Cₚₛ of the sample based on the temperature change of the first calculation step and the temperature change of the second calculation step.

Further, the third calculation step S600 may include a step S610 of selecting a maximum temperature rise value ΔTₘₐₓ and a maximum time tₘₐₓ (defined as 15 times t_{1/2}) at a rear surface with respect to the measured sample and a standard sample, a step of dividing an elapsed time t of each of the measured sample and the standard sample by the maximum time tₘₐₓ, a step of calculating a temperature rise value ΔT, of the measured sample and a temperature rise value ΔT, of the standard sample by integrating predetermined sections of a non-dimensional time t/tₘₐₓ based on a temperature rise ΔT with respect to non-dimensional time t/tₘₐₓ, which is divided with respect to the measured sample and the standard sample, and a step of calculating specific heat Cₚₛ of the measured sample from the following equation based on the temperature rise value ΔT, of the measured sample and the temperature rise value ΔT, of the standard sample:

$${C}_{ps} = \frac{{ρ}_{r} {l}_{r} {C}_{pr} Δ {T}_{r}}{{ρ}_{s} {l}_{s} Δ {T}_{s}}$$

where ρᵣ is the density of the standard sample, ρₛ, is the density of the measured sample, lᵣ, is the thickness of the standard sample, lₛ is the thickness of the measured sample, and Cₚᵣ is the specific heat of the standard sample.

### BRIEF DESCRIPTION OF THE DRAWINGS

Further objects and advantages of the invention can be more fully understood from the following detailed description taken in conjunction with the accompanying drawings in which:

FIG. 1 is a plan view of a specific heat measurement apparatus using flash according to the present invention;

FIG. 2 is a exploded perspective view of the specific heat measurement apparatus illustrated in FIG. 1;

FIG. 3 is a partial cross-sectional view of the specific heat measurement apparatus illustrated in FIG. 1;

FIG. 4 is a theoretical graph regarding temperature rise at the rear surface of a sample; and

FIG. 5 is a graph showing integrated sections in the range of 0.5 to 1.5 times of the half time of the temperature rise curve in a non-dimensional time axis.

### DETAILED DESCRIPTION OF THE PREFERRED EMBODIMENT

The present invention will now be described in detail in connection with a specific embodiment with reference to the accompanying drawings.

(Construction)

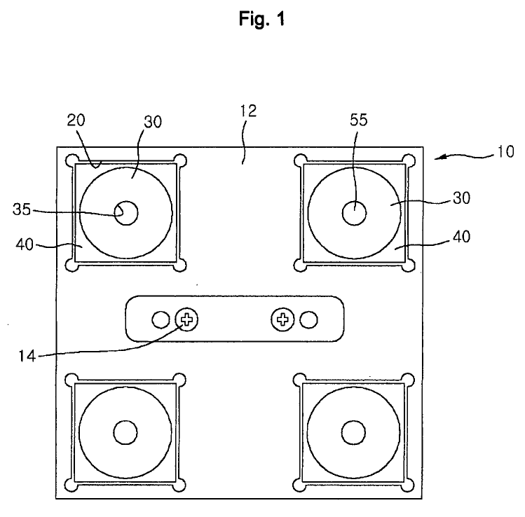

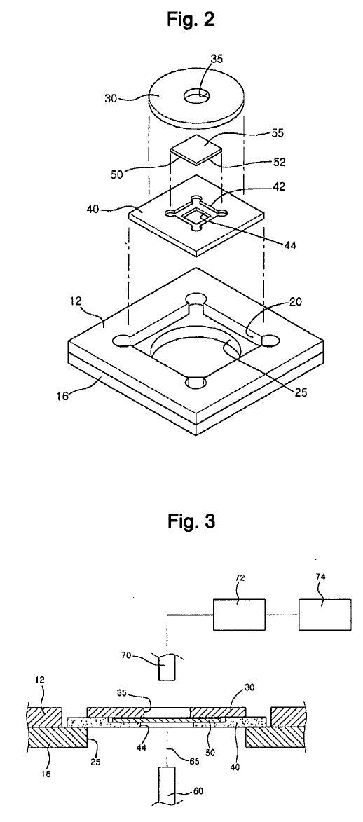

FIG. 1 is a plan view of a specific heat measurement apparatus using flash according to the present invention. FIG. 2 is a exploded perspective view of the specific heat measurement apparatus illustrated in FIG. 1. FIG. 3 is a partial cross-sectional view of the specific heat measurement apparatus illustrated in FIG. 1.

The specific heat measurement apparatus according to the present invention largely includes, as illustrated in FIGS. 1 to 3, first and second sample holder plates 12, 16, a sample holder 40, a sample 50, a sample cover 30 and surrounding measurement devices.

The first sample holder plate 12 is made of steel and has a first through-hole 20 of a square shape formed therein. The first through-hole 20 can have a regular square whose one side is 3 cm in length. Four or more through-holes 20 can be formed in one first sample holder plate 12, as illustrated in FIG. 1.

The second sample holder plate 16 is also made of steel, and is closely adhered and fixed to one side of the first sample holder plate 12 by means of a mating unit 14, such as the screw. The second sample holder plate 16 has a second through-hole 25 formed therein. The second through-hole 25 has a diameter less than 3 cm. It serves to support the sample holder 40 without falling down when the sample holder 40 is placed horizontally.

The sample holder 40 is a member to hold the sample 50. The sample holder 40 is made of steel and has a length less than 3 cm in one side so that it can be inserted into the first through-hole 20. A second square-shaped holder hole 42 is formed at the center of the sample holder 40. The thickness of the second square-shaped holder hole 42 is half of that of the sample holder 40. A first square-shaped holder hole 44 is formed at the center of the second square-shaped holder hole 42. The thickness of the first square-shaped holder hole 44 is the same as that of the second square-shaped holder hole 42.

The second square-shaped holder hole 42 is the space at which the square sample 50 is directly placed. The first square-shaped holder hole 44 forms a path along which a laser beam 65 is directly irradiated on the sample 50.

The sample 50 is an object whose specific heat will be measured, and has a regular square cross-section whose one side is at most 8 mm in length. Black graphite coating is coated on the surface of the sample 50 in order to accelerate the absorption of heat by flash and the radiation of infrared rays.

The sample cover 30 is made of steel and has a circular disk shape. The external diameter of the sample cover 30 is within 3 cm so that it can be inserted into the first through-hole 20. A covering hole 35 is formed at the center of the sample cover 30. The covering hole 35 forms a path along which infrared rays emitted from the sample 50 passes. The covering hole 35 has an inside diameter of 6 to 8 mm. The sample cover 30 and the covering hole 35 serve to prevent excessive flash and apply constant energy.

A laser oscillation unit 60 can include any kinds of xenon flash, other light, etc. only if it is flash emitting light. The laser oscillation unit 60 is disposed vertically under the sample 50. The surface of the sample 50 is exposed so that the laser beam 65 can be directly irradiated on it.

An infrared detector 70 is placed vertically over the sample 50, and is a member for measuring infrared rays emitted from the sample 50 and outputting it as an electrical signal (voltage or resistance).

A signal processor 72 is connected to the infrared detector 70 and a calculation unit 74. The signal processor 72 includes an amplification unit (not illustrated), a bandpass filter (not illustrated) and an A/D converter (not illustrated) in order to amplify and filter an output signal of the infrared detector 70 and convert the resulting signal into a discrete signal.

The calculation unit 74 is a member that calculates a specific heat value of the sample 50 by performing an operation according to a predetermined operation method based on a signal input from the signal processor 72. The calculation unit 74 can include a computer, a microcomputer, a CPU or the like.

(Experiment Method)

A measurement method of the specific heat measurement apparatus using flash is described in detail below. One surface 52 of the sample 50 whose specific heat will be measured is heated by instant light of flash. Thereafter, a temperature on the other surface 55 of the sample 50 rises as time goes by.

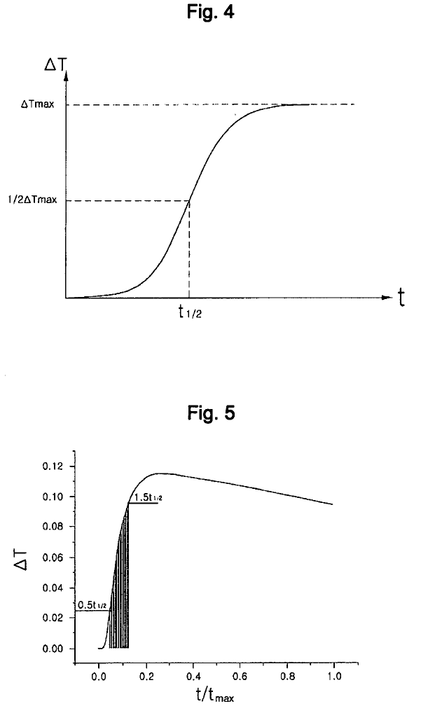

FIG. 4 is a theoretical graph regarding the temperature rise on the rear surface of the sample. In order to measure the thermal diffusivity, the maximum time tₘₐₓ, which is 15 times of the half time, is required. The specific heat was obtained by dividing an elapsed time by the maximum time tₘₐₓ to have non-dimension and comparing the temperature rises between a standard sample and the measured sample 50 depending on the non-dimension time axis t/tₘₐₓ.

It was found that the specific heat had the reproducibility and accuracy of within 2% without regard to the thickness and properties of material in the integrated sections between 0.5 and 1.5 times of the half time on the curve of the non-dimensional time axis versus the temperature rise. This is a method of measuring the specific heat accurately within a short period of time in comparison with the conventional specific heat measurement method having the error of 10% or more and the DSC specific heat measurement method having the error of 5%.

In the specific heat measurement apparatus using flash according to the present invention, the specific heat can be obtained by comparing the temperature rises at the standard sample and the other surface 55 of the sample 50. If one surface 52 of the sample 50 is heated by flash (for example, the laser beam 65), the temperature rise at the other surface 55 of the sample 50 at any time can be written as:

$$\frac{Δ T}{Δ {T}_{max}} = 1 + 2 [ {\sum }_{n = 1}^{∞} {( - 1 )}^{n} \cdot exp ( - {n}^{2} 2 {π}^{2} α {tl}^{- 2} ) ] \qquad ( 2 )$$

where α and l are the thermal diffusivity and thickness of the sample 50 respectively, ΔT is temperature rise at the other surface 55 of the sample 50 depending on time, ΔTₘₐₓ is the maximum temperature value at the other surface 55 of the sample 50, and t is time after the heating of flash (i.e. pulse wave).

Designating the time when the temperature rise ΔT at the other surface 55 of the sample 50 reaches half of the maximum temperature value ΔTₘₐₓ after the heating of flash (i.e. pulse wave) as the half time t_{1/2}, the thermal diffusivity a can be obtained from Equation 3 as follows.

$$α = \frac{0.138785 {l}^{2}}{{t}_{1 / 2}} \qquad ( 3 )$$

The specific heat measurement method according to the present invention is described below. When the flash energy Q is irradiated uniformly on the standard sample and the measured sample 50 at a rate per unit area and time, the temperature rises of the standard sample and the measured sample 50 can be expressed by the following Equations 4 and 5.

$$\begin{matrix}Δ {T}_{r} = {[ \frac{Q}{ρ {lC}_{p}} ]}_{r} & ( 4 ) \\ Δ {T}_{s} = {[ \frac{Q}{ρ {lC}_{p}} ]}_{s} & ( 5 )\end{matrix}$$

where the suffixes r and s are the standard sample and the measured sample 50 respectively, and ρ is the sample density. The specific heat Cₚₛ of the sample 50 can be determined by comparing the temperature rise of the measured sample 50 to that of the standard sample with known specific heat based on Equation 6.

$${C}_{ps} = \frac{{ρ}_{r} {l}_{r} {C}_{pr} Δ {T}_{r}}{{ρ}_{s} {l}_{s} Δ {T}_{s}} \qquad ( 6 )$$

In the specific heat measurement method according to an embodiment of the present invent, after the heating of flash (i.e. pulse wave) in order to measure the thermal diffusivity a of the sample 50, the maximum time tₘₐₓ at the other surface 55 of the sample 50 was measured as 15 times of the half time t_{1/2} so as to obtain a data correction coefficient. The temperature change ΔT at the other surface 55 of the sample 50 after the heating of flash (i.e. pulse wave) depends on the properties and the thickness of material, and the maximum time tₘₐₓ also differs from material to material.

In the present invention, the specific heat of the test sample can be obtained by dividing each elapsed time t by the maximum time tₘₐₓ to have non-dimension, and comparing the temperature rises between the standard sample and the measured sample 50 depending on the non-dimensional time axis t/tₘₐₓ through integration of predetermined sections of the non-dimensional time axis. This process is shown in the graph of FIG. 5. FIG. 5 is a graph showing the integrated sections in the range of 0.5 to 1.5 times of the half time of the temperature rise curve in the non-dimensional time axis.

Table 1 compares the measurement of NIST standard sample (Pyrex 7790, Polycrystalline Alumina, Copper RM 5) at normal temperature by using the specific heat measurement apparatus and method according to the present invention. As can be seen from Table 1, the measured sample 50 was material having a different thermal conductivity (Pyrex: 1.098 W/mk, Alumina: 30.92 W/mk, Copper: 404.2 W/mk) and having a thickness of 1 to 3 mm. The measured sample 50 was compared with the standard sample. It was found that there are accuracy and reproducibility of within 2%.

TABLE 1

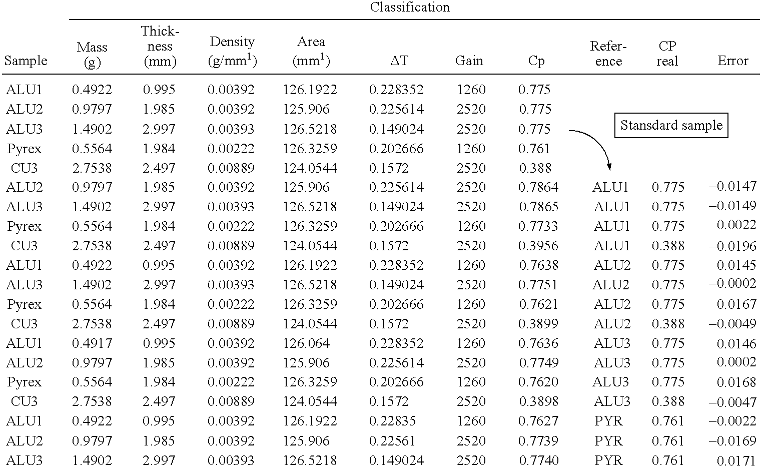

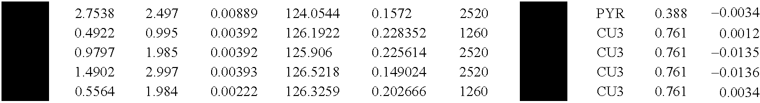

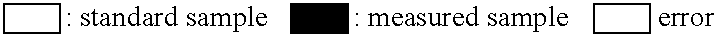

As described above, according to an embodiment of the present invention, the thermal diffusivity and the specific heat can be measured at the same time accurately, and the thermal conductivity can be measured further rapidly and accurately.

While the present invention has been described with reference to the particular illustrative embodiments, it is not to be restricted by the embodiment but only by the appended claims. It is to be appreciated that those skilled in the art can change or modify the embodiments without departing from the scope and spirit of the present invention.

What is claimed is:

1. An apparatus for measuring specific heat using flash, comprising:
sample fixing means for fixing a sample having two surfaces so that each of both surfaces of the sample is partially exposed;
flash irradiation means for irradiating flash to a first surface of the sample, which is exposed by the sample fixing means;
a light-receiving detector for receiving light irradiated from a second surface of the sample, which is exposed by the sample fixing means; and
a calculation unit for calculating specific heat of the sample based on an output signal of the light-receiving detector.

2. The specific heat measurement apparatus as claimed in claim 1, wherein the sample fixing means comprises:
a sample holder having a first holder hole formed penetratingly therein so that the first surface of the sample is exposed and a second holder hole for accommodating the sample therein;
a sample cover placed on the sample holder and having a covering hole formed penetratingly therein so that the second surface of the sample is exposed; and
a sample holder plate in which the sample holder is seated.

3. The specific heat measurement apparatus as claimed in claim 2, wherein the sample holder plate comprises:
a first sample holder plate formed with a first through-hole for inserting the sample holder thereto; and
a second sample holder plate fixed closely to one surface of the first sample holder plate and having a second through-hole formed therein, the second through-hole being smaller than the first through-hole.

4. The specific heat measurement apparatus as claimed in claim 3, wherein plural pairs of first and second through-holes are formed in the first and second sample holder plates.

5. The specific heat measurement apparatus as claimed in claim 1, wherein the flash irradiation means includes a laser oscillation unit or a xenon flash.

6. The specific heat measurement apparatus as claimed in claim 1, wherein the flash irradiated by the flash irradiation means includes a pulse wave.

7. The specific heat measurement apparatus as claimed in claim 5, wherein the flash irradiated by the flash irradiation means includes a pulse wave.

8. The specific heat measurement apparatus as claimed in claim 1, wherein the light-receiving detector includes an infrared detector.

9. The specific heat measurement apparatus as claimed in claim 1, wherein black graphite is coated on the both surfaces of the sample.

10. A method for measuring specific heat using flash, comprising:
a sample fixing step of fixing a sample having a first and second surface whose specific heat will be measured so that each of the first and second surfaces of the sample are partially exposed;
a step of irradiating flash to the first surface of the sample;
a step of allowing a light-receiving detector to measure light at the second surface of the sample;
a first calculation step of calculating a temperature change at the second surface of the sample according to the lapse of time t based on an output signal of the light-receiving detector;
a second calculation step of calculating the temperature change by performing the sample fixing step to the first calculation step with respect to a standard sample having a known specific heat Cₚᵣ; and
a third calculation step of calculating a specific heat Cₚₛ of the sample based on the temperature change of the first calculation step and the temperature change of the second calculation step.

11. The specific heat measurement method as claimed in claim 10, wherein the third calculation step comprises:
a step of selecting a maximum temperature rise value ΔTₘₐₓ and a maximum time tₘₐₓ at a rear surface with respect to the measured sample and the standard sample;
a step of dividing an elapsed time t of each of the measured sample and the standard sample by the maximum time tₘₐₓ;
a step of calculating a temperature rise value ΔT, of the measured sample and a temperature rise value ΔT, of the standard sample by integrating predetermined sections of a non-dimensional time t/tₘₐₓ based on a temperature rise ΔT with respect to non-dimensional time t/tₘₐₓ, which is divided with respect to the measured sample and the standard sample; and
a step of calculating specific heat Cₚₛ of the measured sample from the following equation based on the temperature rise value ΔT, of the measured sample and the temperature rise value ΔT, of the standard sample:
$${C}_{ps} = \frac{{ρ}_{r} {l}_{r} {C}_{pr} Δ {T}_{r}}{{ρ}_{s} {l}_{s} Δ {T}_{s}}$$
where ρᵣ is the density of the standard sample, ρₛ is the density of the measured sample 50, lᵣ is the thickness of the standard sample, lₛ is the thickness of the measured sample 50, and Cₚᵣ is the specific heat of the standard sample.
